(19) United States
(12) Patent Application Publication
(10) Pub. No.: US 2009/0114102 A1
(43) Pub. Date: May 7, 2009

(54) Steam cooking apparatus

(76) Inventor: Nobuo Achiwa, Aichi-ken (JP)

Correspondence Address: REED SMITH LLP, 3110 FAIRVIEW PARK DRIVE, SUITE 1400, FALLS CHURCH, VA, 22042, US

(21) Appl. No.: 11/979,407

(22) Filed: Nov. 2, 2007

(51) Int. Cl. A47J 27/04

(52) U.S. Cl. 99/410

(57) ABSTRACT

In a steam cooking apparatus in which high temperature steam of alkaline water is used as the heat source for cooking food materials, alkaline water is used as the water source of the steam to remove off fats and proteins from the food materials thereby to provide healthy cooked foods.

### BACKGROUND OF THE INVENTION

1. Field of the Invention

The present invention relates to a steam cooking apparatus in which steam of high temperature is applied as the heat source for cooking food materials contained in a heat cooking cabinet.

2. Discussion of the Prior Art

In a heat cooking apparatus for cooking food materials by heat, a heater is, in general, provided to heat the food materials contained in a heat cooking cabinet. Disclosed in Japanese Patent Laid-open Publication No. 1995-133932 is a cooking apparatus of the type in which steam is supplied into a heat cooking cabinet and in which the humidity in a heated atmosphere is adjusted in accordance with a food material to be cooked. Disclosed also in Japanese Patent Laid-open Publication No. 2004-198007 is a heat cooking apparatus of the type in which overheated steam is applied as the heat source for cooking food materials contained in a heat cooking cabinet. In the heat cooking apparatus of this type, overheated steam of 100° C.˜300° C. is applied as the heat source to remove off excessive of fat and salt constituents in the food material for reduction of calorie and salt of cooked food.

### SUMMARY OF THE INVENTION

An object of the present invention is to provide a steam cooking apparatus in which high temperature steam such as overheated steam is applied as the heat source effective to remove off excessive fat and protein constituents in a food material during cooking process thereby to provide healthy cooked food.

According to the present invention, the object is attained by providing a steam cooking apparatus wherein high temperature steam of alkaline water is used as the heat source for cooking a food material contained in a cooking cabinet. In the steam cooking apparatus, the food material can be cooked by high temperature steam produced by heating electrolyzed alkaline water. During the cooking process of the food material, the steam of the electrolyzed alkaline water is useful to effectively remove off excessive fats and proteins on the surface of the food material thereby to provide healthy cooked food. As the heat conductivity of the steam of the electrolyzed alkaline water is higher than that of steam of usual water such as tap water, the heating time for cooking can be shortened, and the fats and proteins adhered to the interior wall of the heat cooking cabinet can be easily removed.

### BRIEF DESCRIPTION OF THE DRAWING

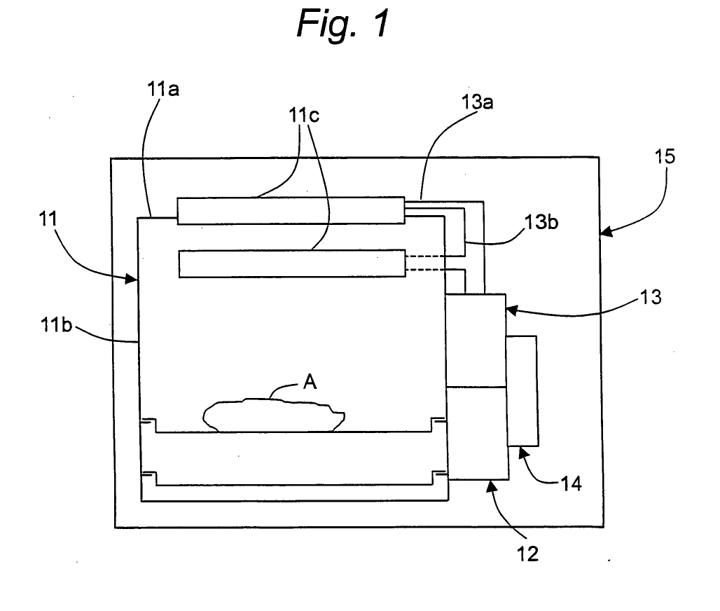

In the drawing, FIG. 1 is a schematic illustration of an embodiment of a steam cooking apparatus according to the present invention.

### DESCRIPTION OF THE PREFERRED EMBODIMENT

Illustrated in FIG. 1 is an embodiment of a steam cooking apparatus according to the present invention. The steam cooking apparatus is in the form of a cooking apparatus of the type in which overheated steam is used as the heat source basically in a conventional construction. The steam cooking apparatus is composed of a heat cooking cabinet 11, a steam generator 12, an overheated steam generator 13 and a controller 14 assembled in a housing 15.

The steam generator 12 includes a water tank to store an amount of water for generation of steam and heating means such as a heater for heating the water stored in the water tank. The water in the water tank is boiled by activation of the heating means for generating the steam. The overheated steam generator 13 includes a steam tank to be supplied with the steam and heating means such as a heater for heating the steam supplied into the steam tank. The steam introduced into the steam tank is heated by activation of the heating means for generating the overheated steam. In the overheated steam generator 13, the temperature of the overheated steam is appropriately adjusted to an extent of 100° C.˜300° C. under control of the controller 14.

The heat cooking cabinet 11 is provided at its front with a door of the open-close type and at its upper wall 11a and side walls 11b with steam spout portions 11c. The steam spout portions 11c are connected to steam supply conduits 13a, 13b of the overheated steam generator 13, respectively. The steam spout portions 11c belch up the overheated steam into the heat cooking cabinet 11 for cooking food materials A contained therein. When the temperature of the overheated steam is set approximately at 300° C., fishes or meats can be grilled.

In the steam cooking apparatus, alkaline water is used as the water source of steam. The alkaline water may be selectively provided in the form of strong alkaline water produced by electrolysis of diluted salt water in an electrolytic cell with a membrane, weak alkaline water produced by electrolysis of tap water in an electrolytic cell with a membrane, weak alkaline water produced by electrolysis of diluted salt water in an electrolytic cell without a membrane or in the form of weak alkaline solution obtained by solution of NaOH, KOH or the like permitted as an additive free food. As different in removal function of fats and proteins, the alkaline water is selectively used in accordance with the kind of food materials A.

With the steam cooking apparatus, food materials A contained in the cooking cabinet 11 can be cooked (or thawed) by high temperature steam of the alkaline water. During the cooking process, excessive fats and proteins on the surface of the food material are removed off to provide healthy cooked food. The steam of alkaline water is useful to effectively remove off the excessive fats and proteins on the surface of the food material. When the temperature of steam is maintained approximately at 300° C., meats or fishes can be grilled. As the heat conductivity of the high temperature steam of alkaline water is higher than that of the high temperature steam of usual water such as tap water, the heating time of the food materials during the cooking process is shortened, and the fats and proteins adhered to the interior of the cooking cabinet are easily removed off.

Experiments:

The steam cooking apparatus shown in FIG. 1 was used for comparative experiments of the heat cooking by the overheated steam of alkaline water and the heat cooking by the overheated steam of tap water. For use of the steam cooking apparatus, strong alkaline water of pH 11.5 at 20° C. produced by electrolysis of diluted salt water in a cathode chamber of an electrolytic cell was used to generate the steam of alkaline water. Listed in the following tables 1 and 2 are food materials to be cooked, the temperature of the overheated steam, and the heating time.

In the comparative experiments, the food materials A were contained in an upper step of the heat cooking cabinet 11, and a beaker was faced to the bottom portion of the food materials to receive liquid falling from the food materials until finish of the cooking process. Thus, the weight of liquid collected in the beaker was measured as a removed amount of fats and proteins. In addition, the weight of the cooked foods was measured to calculate a difference between the weights of the food materials before and after cooking. A result of the measurement is listed in the following tables 1 and 2.

TABLE 1

| Food | | | | |
|---|---|---|---|---|
| (Heating time) | | Weight of beaker | | Removed |
| (Steam temp.) | Test water | Before cooking | After cooking | weight |
| Yellowtail 1st | 1 | 111.857 | 114.102 | 2.245 |
| (20 minutes) | 2 | 105.444 | 109.059 | 3.615 |
| (300° C.) | | | | |
| Hamburger | 1 | 114.181 | 117.226 | 3.045 |
| (20 minnutes) | 2 | 114.981 | 118.527 | 3.546 |
| (300° C.) | | | | |
| Yellowtail 2^{nd} | 1 | 109.686 | 110.338 | 0.652 |
| (20 minutes) | 1 | 109.646 | 110.813 | 1.167 |
| (300° C.) | | | | |
| Eel | 1 | 112.970 | 113.215 | 0.245 |
| (20 minutes) | 2 | 108.998 | 111.006 | 2.008 |
| (300° C.) | | | | |
| Chicken mince | 1 | 108.201 | 108.672 | 0.471 |
| (20 minutes) | 2 | 110.567 | 111.235 | 0.668 |
| (300° C.) | | | | |

Note:
Test water 1: Tap water
Test water 2: Electrolyzed alkaline water (pH 11.5)
Beaker weight: Before cooking: Empty condition After cooking: Collected condition

TABLE 2

| Food | | | | Removed |
|---|---|---|---|---|
| (Heating time) | | Weight of food (g) | | weight |
| (Steam temp.) | Test water | Before cooking | After cooking | Difference |
| Yellowtail 1st | 1 | 152.0 | 119.5 | 32.5 |
| (20 minutes) | 2 | 152.0 | 114.3 | 37.7 |
| (300° C.) | | | | |
| Hamburger | 1 | 88.7 | 64.4 | 24.3 |
| (20 minnutes) | 2 | 88.7 | 64.2 | 24.5 |
| (300° C.) | | | | |
| Yellowtail 2^{nd} | 1 | 80.7 | 61.7 | 19.0 |
| (20 minutes) | 1 | 80.3 | 58.6 | 21.7 |
| (300° C.) | | | | |
| Eel | 1 | 80.3 | 50.6 | 29.7 |
| (20 minutes) | 2 | 80.0 | 50.6 | 29.4 |
| (300° C.) | | | | |
| Chicken mince | 1 | 82.3 | 60.9 | 21.4 |
| (20 minutes) | 2 | 82.3 | 59.3 | 23.0 |
| (300° C.) | | | | |

Note:
Test water 1: Tap water
Test water 2: Electrolyzed alkaline water (pH 11.5)

1. A steam cooking apparatus in which high temperature steam is applied as the heat source for cooking food materials contained in a heat cooking cabinet, wherein alkaline water is used as the water source of the steam such that the food materials are cooked by high temperature steam of the alkaline water.

2. A heat cooking apparatus as claimed in claim 1, wherein electrolyzed alkaline water produced by electrolysis of water in a electrolytic cell is used as the alkaline water.

3. A heat cooking apparatus as claimed in claim 1, wherein overheated steam is used as the heat source.
